(19) United States
(12) Patent Application Publication
(10) Pub. No.: US 2013/0254071 A1
(43) Pub. Date: Sep. 26, 2013

(54) METHOD AND SYSTEM FOR PROVIDING ANONYMITY TO A CONSUMER

(71) Applicant: Michael Oley, Goochland, VA (US)

(72) Inventor: Michael Oley, Goochland, VA (US)

(21) Appl. No.: 13/481,812

(22) Filed: May 26, 2012

Related U.S. Application Data
(60) Provisional application No. 61/615,314, filed on Mar. 25, 2012.
(60) Provisional application No. 61/644,394, filed on May 8, 2012.

(51) Int. Cl. G06Q 30/06

(52) U.S. Cl. 705/26.42

(57) ABSTRACT

A system and a method comprise connecting to a proxy business. The proxy business is configured for conducting a transaction as a proxy for a consumer. Details, of an item for which said proxy business is to conduct a transaction and identifying information for said consumer, are transferred to the proxy business. Final transaction details and terms of acceptance are received from the proxy business. An acceptance of the final transaction details and terms is communicated to the proxy business. The proxy business initiates a consumer transaction with the consumer. The proxy business further communicates an order, to the vender, for the item in the name of the proxy business. The vender completes the order by making available the item to the proxy business. The item is received from the proxy business to complete the consumer transaction in which the consumer remains anonymous to the vender.

### CROSS-REFERENCE TO RELATED APPLICATIONS

The present Utility patent application claims priority benefit of the U.S. provisional application for patent serial number 61615314 entitled “A Method and System for Providing Anonymity to a Consumer”, filed on 25-Mar.-2012, and provisional patent serial number 61644394, filed on 8-May-2012, both of which were filed under 35 U.S.C. 119(e). The contents of these related provisional applications are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to purchasing of goods and services. More particularly, the invention relates to privacy protection and anonymity for consumers buying products and services.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is believed that consumers often desire to buy goods and services anonymously to protect their privacy and their identity. Often, on-line vender's fail to provide a level of anonymity the customer desires. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that some software and hardware applications provide anonymous or one-time use credit card numbers in an attempt to protect privacy and identity.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for anonymity, in accordance with an embodiment of the present invention;

FIGS. 2a, 2b and 2c illustrate an exemplary method for anonymity, in accordance with an embodiment of the present invention;

FIG. 3 illustrates an exemplary method for selecting an item for purchase using a proxy; and

FIG. 4 illustrates a typical computer system that, when appropriately configured or designed, can serve as a computer system in which the invention may be embodied.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Some embodiments of the present invention may provide for methods and systems for enabling a customer to purchase goods and services anonymously. In some embodiments and variations thereof, a proxy business provides an identity protector for the consumer by enabling the consumer to place an order for goods and services with the proxy business and then the proxy business will place the order with a vender using with its own accounts and own names to facilitate the anonymous purchasing and/or shipping of the chosen service and/or product. In some embodiments, the customer may place the order using a website of the proxy business. In some embodiments, the customer may choose to visit the proxy business's website through a ghost proxy to provide a degree anonymity with an internet service provider. In other embodiments, the customer may place the order with the proxy business by means such as, but not limited to, phone, fax, secure text or messaging, dedicated application for mobile devices, kiosk, smart TV, etc. In some embodiments, the service personal of the proxy business may assist the consumer in placing the order. The assistance may be provided by, but not limited to, online chat, secure text or messaging, phone, etc. In alternate embodiments, the customer's order placement may be accomplished without assistance. In some of these alternate embodiments, the customer may provide the proxy business with the website of the vender from which to purchase the item. The proxy business may then visit the vender's website using the proxy business's name and account, and then share the screen with the customer to enable the customer to navigate and choose the desired item. Upon the customer making a choice, the proxy business's website may finalize the purchase with the customer and the vender.

Some embodiments of the present invention may provide for shipping the item from the vender directly to the proxy business. The proxy business may then reship the item to the customer. In some other embodiments, the item may be shipped to an affiliate of the proxy business for reshipping to the customer. The affiliate may obtain the customer's address from the proxy business for labeling purposes, but would not retain the customer's address.

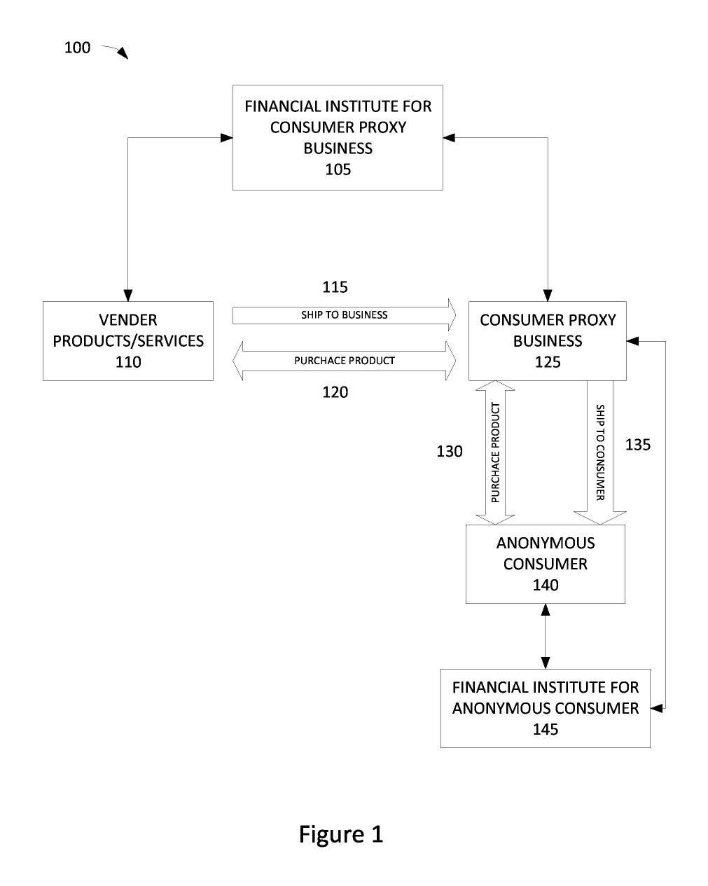

FIG. 1 illustrates an exemplary system for anonymity, in accordance with an embodiment of the present invention. In exemplary system 100 depicted, consumer 140, wishing to remain anonymous to vender 110, contacts proxy business 125 to place an order for an item. Consumer 140 may typically contact proxy business through the proxy business's website. In some embodiments, the consumer may choose to utilize a ghost proxy to provide a degree anonymity with an internet service provider. Consumer 140 may fund the transaction using their financial institute 145. Proxy business 125 contacts vender 110 using the proxy business's name, accounts and shipping address to place an order on behalf of consumer 140. Proxy business 125 may use their financial institute 105 to fund the transaction. Upon completion of the order, vender 110 ships the item to the proxy business's shipping address. Upon receipt of the item, the item is relabeled and shipped to consumer 140. During the process of obtaining the item, consumer 140 remains anonymous to the vender 110.

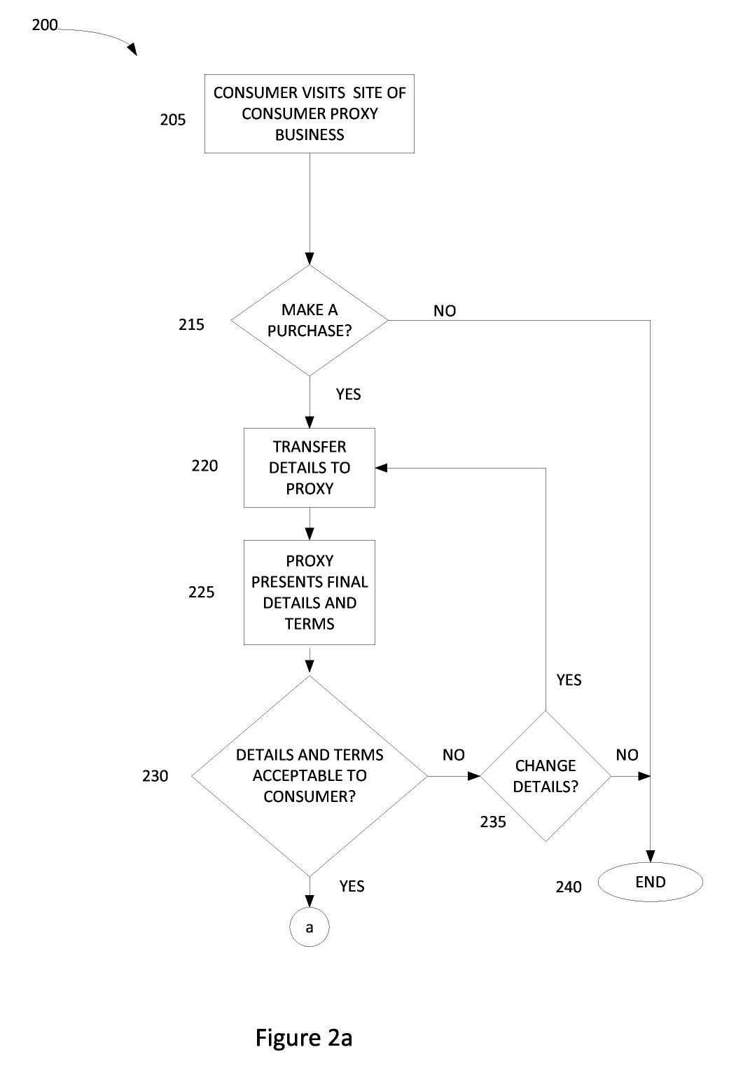

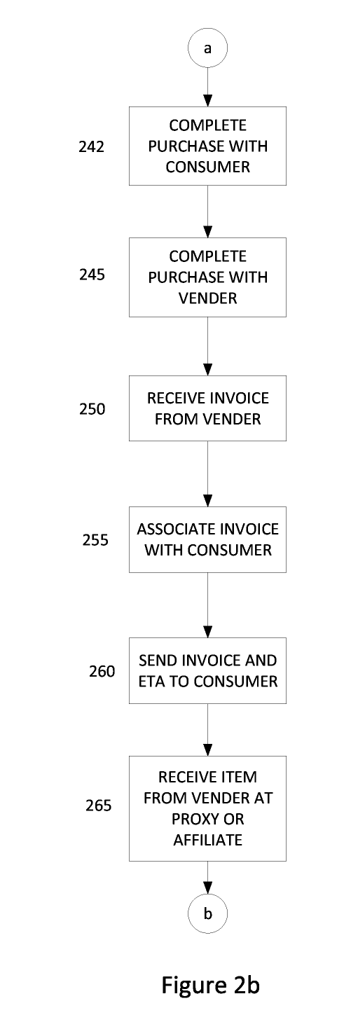

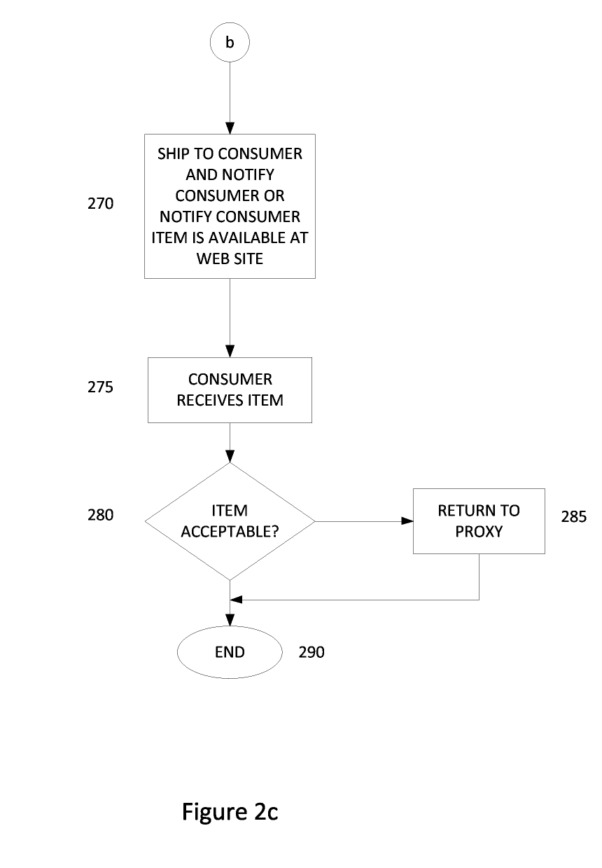

FIGS. 2a, 2b and 2c illustrate an exemplary method for anonymity, in accordance with an embodiment of the present invention. Consumer 140 desiring to make anonymous purchases visits proxy business 125. In some other embodiments, consumer 140 may choose to utilize a ghost proxy to provide anonymity with an internet service provider. Upon a determination to purchase an item 215, details for purchase of the item are transferred to proxy business 125 in step 220. Details may comprise, but not limited to, vender name, item description, item product number, price, etc., and customer's name, address, shipping address, email address, phone number, payment method, card account number, etc. In some embodiments, consumer 140 may manually enter details. In other embodiments, service personal of the proxy business may assist the consumer in placing the order. The assistance may be provided by, but not limited to, online chat, secure text or messaging, phone, etc. In alternate embodiments, the item details may be provided automatically without assistance. In a non-limiting example, the item details may be transferred from a vender's website. One of ordinary skill will readily recognize that there are numerous means for transferring the item details. In step 225, proxy business 125 presents final purchase details and terms of agreement to consumer 140. Purchase details may include, but not limited to, item details, availability, price, taxes, shipping method, shipping fees, fees for the proxy business, estimated time to complete the order, etc. The purchase details are then presented to consumer 140. In alternate embodiments, proxy business 125 may perform a search of other venders that that may provide the same or similar item. The search results would then be presented to consumer 140 for consideration. Upon revue of the purchase details and terms, consumer 140 makes a determination 230 if they are acceptable. If they are not acceptable, consumer 140 makes a determination 235 whether change some item details or to end 240. Upon a determination 230 to accept the purchase details, proxy business completes the purchase with consumer 140 in step 242. In a non-limiting example, proxy business may verify sufficient funds or credit with consumer's financial institute 145. In step 245 proxy business 125 completes purchase of the item with vender 110 using at least proxy business's name, contact information, shipping address and financial account. In a non-limiting example, vender may verify sufficient funds or credit with proxy business financial institute 105. Upon completion of the order with vender 110, proxy business 125 may receive an order confirmation and/or invoice from vender 110 in step 250. In step 255 proxy business 125 may associate the order confirmation and/or invoice with consumer 140. In step 260 proxy business 125 may send an order confirmation and/or invoice to consumer 140 along with an estimated time of arrival for the item. In some embodiments, proxy business 125 may forward other communications from the vender 110 to consumer 140. In step 265 proxy business receives the item from vender 110. In some embodiments, an affiliate or contracted entity may receive the item for proxy business 125. In step 270 if the item is a product, the item is at least relabeled with the consumers name and shipping address. The consumers name and shipping address may be obtained by comparison to associations made in step 250. The item may then be shipped to consumer 140 by proxy business 125 or the affiliate or contracted entity. If the affiliate or contracted entity is the shipper, the consumer's name and shipping address is not retained to protect the anonymity of consumer 140. If the item is a service, proxy business 125 may notify consumer 140 that the item is available by visiting proxy business's website. In step 275 consumer 140 receives the item. In step 280 consumer 140 may make a determination if the item is acceptable. If the item is not acceptable, consumer 140 may return it proxy business 125.

One of ordinary skill will appreciate that the exemplary steps described herein may change or altered within the teachings of the present invention in where proxy business remains the only entity to be aware of or retain consumer's information regarding purchase of the item. It is contemplated that some of the proxy business's operations may be contracted out to other entities, but only proxy business 125 will retain customer's identifying information. In some alternate embodiments, purchase order information for consumer may be removed from proxy business's system after a period of time.

One of ordinary skill will appreciate that the teachings of the present invention may be used in other business transactions such as, but not limited to, an awarding of contracts, an auction process, and any type of business model that would benefit from a layer of anonymity between the entity giving and/or obtaining and the entity receiving.

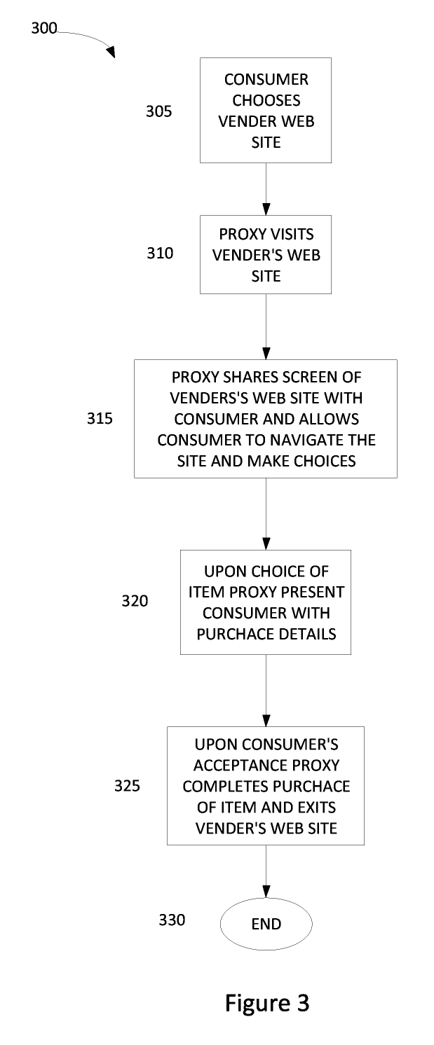

FIG. 3 illustrates an exemplary method for selecting an item for purchase using a proxy. Method 300 illustrates an alternative process for automatic identification of item details for purchase by consumer 140. Referring to FIG. 2a, step 220 may comprise elements of method 300. In step 305 consumer 140 selects a desired vender's website. In some embodiments the vender's website may be entered by means such as, but not limited to, typing the address, pasting in a copied address, or selection from a list of favorites. In some other embodiments, proxy business 125 may additionally provide a list of venders to choose from. I step 310 proxy business's website visits the selected vender's website. In step 315, proxy business's website initiates a shared session of the visit with consumer 140 in which consumer is enabled to view vender's site, navigate the site and make product choices. Consumer 140 may then shop the vender's website under proxy business's identity. In step 320 after consumer has made final selections of, but not limited to, item(s) and shipping method, the proxy business's website may disable sharing of the website visit. In a non-limiting example, this may occur during a “check-out” process on the vender's website. In step 320 proxy business's website presents consumer 140 with purchase details for purchasing the item(s) through proxy business 125. In step 325, upon consumer's acceptance of purchase details, the proxy business's website completes the purchase with the vender's website and exits the vender's website.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

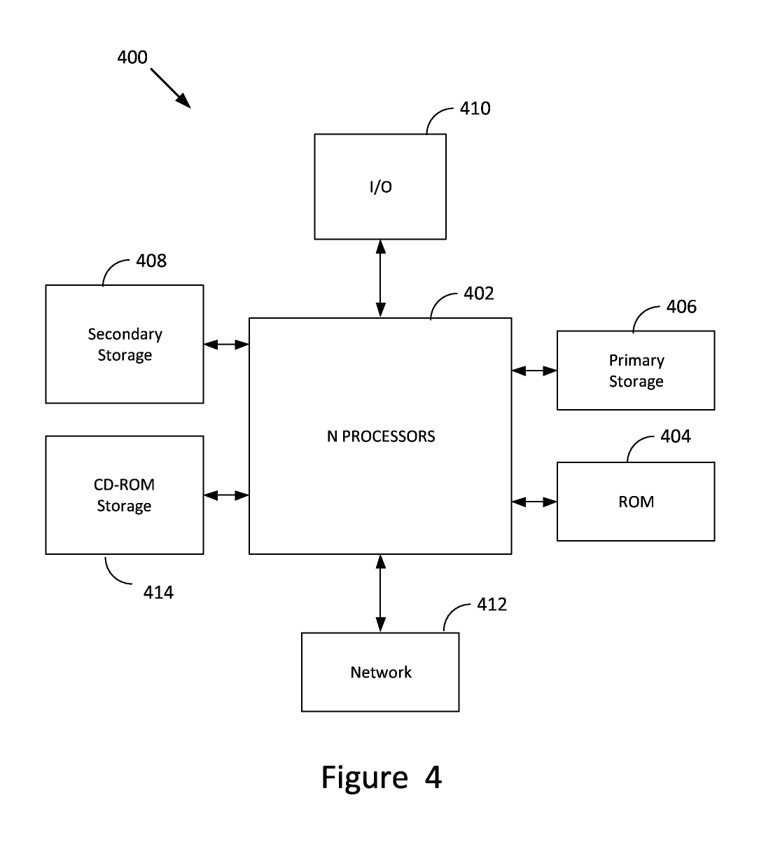

FIG. 4 illustrates a typical computer system that, when appropriately configured or designed, can serve as a computer system in which the invention may be embodied. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable non-transitory computer-readable media such as those described above. A mass storage device 408 may also be coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection as shown generally at 412, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: processing orders to the vender, processing customer orders, and customer support.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of anonymous purchasing according to the present invention will be apparent to those skilled in the art. The invention has been described above by way of illustration, and the specific embodiments disclosed are not intended to limit the invention to the particular forms disclosed. For example, the particular implementation of the interaction between the consumer and the proxy business may vary depending upon preferences of the consumer. In a non-limiting example, the consumer may prefer direct communication with a service representative rather than using a website. The methods and systems described in the foregoing were directed to purchasing an item, however, similar techniques are applicable to awarding of contracts, an auction process, and any type of business model that would benefit from a layer of anonymity between the entity giving and/or obtaining and the entity receiving. Such implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
connecting to a proxy business using at least a network connection, said proxy business being configured to be operable for at least conducting a transaction as a proxy for a consumer;
transferring, to said proxy business, details of an item for which said proxy business is to conduct a transaction on behalf of said consumer and identifying information for said consumer;
receiving, from said proxy business, at least final transaction details and terms of agreement;
communicating, to said proxy business, at least an acceptance of said final transaction details and terms, said proxy business processing at least said acceptance and said final transaction details to initiate a consumer transaction with said consumer, said proxy business further communicating an order, to a vender, in the name of said proxy business, said vender completing said order by making available said item to said proxy business; and
receiving, from said proxy business, said item to complete said consumer transaction in which said consumer remains anonymous to said vender.

2. The method as recited in claim 1, further comprising connecting to a ghost proxy to provide anonymity within said network.

3. The method as recited in claim 1, in which said vender ships said item to said proxy business and said proxy business ships said item to said customer.

4. The method as recited in claim 3, in which said proxy business receives at least an order confirmation from said vender and said proxy business associates said order confirmation with said identifying information of said consumer.

5. The method as recited in claim 4, in which said proxy business addresses said item by comparison to said order confirmation to obtain a shipping address for said consumer.

6. The method as recited in claim 1, in which funds for said order are transferred through a financial institution of said proxy business.

7. The method as recited in claim 6, in which funds for said consumer transaction are transferred through a financial institution of said consumer.

8. The method as recited in claim 1, in which said connecting connects to a website of said proxy business.

9. The method as recited in claim 8, in which said website assists in obtaining said details.

10. A system comprising;
a proxy business unit being configured to be operable for at least conducting a transaction as a proxy for a consumer; and
a communication device being configured to be operable for at least connecting to a proxy business using at least a network connection, said communication device being further configured to be operable for: communicating to said proxy business identifying information for said consumer; transferring, to said proxy business, details of an item for which said proxy business is to conduct a transaction on behalf of said consumer; receiving, from said proxy business, at least final transaction details and terms of agreement; communicating, to said proxy business, at least an acceptance of said final transaction details and terms, said proxy business processing at least said acceptance and said final transaction details to initiate a consumer transaction with said consumer, said proxy business further communicating an order, to said vender, for said item in the name of said proxy business, said vender completing said order by making available said item to said proxy business, in which said consumer receives said item from said proxy business to complete said consumer transaction and said consumer remains anonymous to said vender.

11. The system as recited in claim 10, in which said network connection comprises an Internet.

12. The system as recited in claim 10, in which said vender ships said item to said proxy business and said proxy business ships said item to said customer.

13. The system as recited in claim 12, in which said proxy business receives at least an order confirmation from said vender and said proxy business associates said order confirmation with said identifying information of said consumer.

14. The system as recited in claim 13, in which said proxy business addresses said item by comparison to said order confirmation to obtain a shipping address for said consumer.

15. The system as recited in claim 10, in which funds for said order are transferred through a financial institution of said proxy business.

16. The system as recited in claim 15, in which funds for said consumer transaction are transferred through a financial institution of said consumer.

17. The system as recited in claim 10, in which said proxy business further comprises a website.

18. The system as recited in claim 17, in which said website assists in obtaining said details.

19. A method comprising:
steps for connecting to a proxy business using at least a network connection, said proxy business being configured to be operable for at least conducting a transaction as a proxy for a consumer;
steps for transferring, to said proxy business, at least details of an item for which said proxy business is to conduct a transaction on behalf of said consumer and consumer details for payment and receipt of said item;
steps for receiving, from said proxy business, at least transaction details and terms;
steps for communicating, to said proxy business, at least an acceptance of said transaction details and terms in which said proxy business processes at least said acceptance and said transaction details, communicates an order, to a vender, for said item in the name of said proxy business, said vender completing said order by making available said item to said proxy business; and
steps for receiving, from said proxy business, an availability of said item in which said consumer remains anonymous to said vender.

20. The method as recited in claim 19, further comprising steps for connecting to a ghost proxy to provide anonymity within said network.
